(19) United States
(12) Patent Application Publication
(10) Pub. No.: US 2012/0166971 A1
(43) Pub. Date: Jun. 28, 2012

(54) Social Networking Timeline System And Method

(76) Inventors: Thomas Sachson, Menlo Park, CA (US); David Sachson, Nipomo, CA (US)

(21) Appl. No.: 13/336,797

(22) Filed: Dec. 23, 2011

Related U.S. Application Data
(60) Provisional application No. 61/427,505, filed on Dec. 28, 2010.
(60) Provisional application No. 61/472,108, filed on Apr. 5, 2011.
(60) Provisional application No. 61/488,415, filed on May 20, 2011.
(60) Provisional application No. 61/491,445, filed on May 31, 2011.

(51) Int. Cl. G06F 3/01

(52) U.S. Cl. 715/753

(57) ABSTRACT

The Social Networking Timeline System allows individual timeline authors to record their life histories via online timelines and to upload, store, and share personal history information to a remote database that records, stores, and parses their timeline data, preferably over the Internet. Authors are able to connect to other authors thus establishing social connections. These connections are characterized upon the historical overlaps between all parties based upon their inputs, including but not limited to where they were, what they were doing, what their physical condition was, who their associates were, what things they affiliated with, what their beliefs were, and what events they were close to (manmade or natural) at particular points in time. Further, the information created is searchable (anonymized or not) and connections may be requested between persons with shared historical characteristics.

### CROSS-REFERENCE

This application claims the benefit of U.S. Provisional Applications Nos. 61/427,505, by Sachson, entitled Social Networking Timeline System And Method, filed on Dec. 28, 2010, 61/472,108, by Sachson, entitled Social Networking Timeline System And Method, filed on Apr. 5, 2011, 61/488,415, by Sachson, entitled Social Networking Timeline System And Method, filed on May 20, 2011, and 61/491,445, by Sachson, entitled Social Networking Timeline System And Method, filed on May 31, 2011, the disclosures of which applications are incorporated herein by reference.

### BACKGROUND OF THE INVENTION

User-generated content sharing systems, also known as social networking systems, are growing in popularity in use. Prior art social networking systems include MySpace, Facebook, Friendster, and LinkedIn, among others. These systems typically store information about a user, i.e. a “profile” of the user. Such information may include the user's name, sex, location, schools attended, course of study, occupation, birthday, hobbies, interests, etc. Furthermore, the user may upload pictures, videos, blog/diary entries, or other information as desired.

The core functionality of these social networking systems is the ability to connect the user to other users, such as friends, family, classmates, colleagues, and others. Thus, users of the social networking system may easily share the aforementioned information with the other users.

Unfortunately, the social networking systems of the prior art have one major, and to date, non-obvious drawback. Namely, that information is not focused on a person's long-term, detailed historic information, but instead current information (current marital status, place of work, residence, etc.) and therefore is predominantly current and forward looking. Granted, current information entered into these other systems ultimately becomes historic information with the passage of time, but is viewed as outdated news and therefore gets ignored or deleted.

Another deficiency of the prior art concerns the manner in which people make new connections. Of note, the current art focuses on the “linking” of people based upon pre-existing social connections. By way of example, since Party A already socially “knows” Party B, and Party B already social “knows” Party C, then Party A can be introduced to Party C via the shared, pre-existing social connection provided by Party B who has a relationship with both A and C already. This kind of pre-existing social knowledge validation chain (whether involving three parties or more) is the basis for the social network referred to above. However, these networks fail to build additional connectivity chains between various parties where there is a break in the social connection chain (at least one part of the chain is incomplete since there is no pre-existing social knowledge between two parties), yet there remains an alternative linkage path through a shared historical event. In the case of building a connectivity chain based on shared historical events, the connections can be made between persons who have no known social connections to each other (e.g., some or all of the chain participants have never been introduced to each other whatsoever). In this case, there is an opportunity to add significantly to the prior art by enabling a system and method for connection that does not rely upon previous known social connections but instead relies on shared event histories. For instance, Party A went to the same school as Party B, and Party B went on the same vacation as Party C, and Party A and Party C have a chained degree of separation based upon the two unique shared events of Party B—and the chain not being based upon Party B actually previously having known one or more of Party A or Party B socially.

Therefore, these other systems ignore the huge potential for connecting people based on long past historical similarities (shared events, places, friends, etc.). Given that many hundreds of millions of web participants had active and unique experiences before the broad adoption of the internet (e.g., mid 1990s) there is a great opportunity to connect this population by giving them a social network platform that will allow them to create historical timelines that are based on multiple characteristic and/or event sets (where they physically were located, worked, studied, etc. at a particular point in time in the past.).

With this backward in time focus, the current invention is better able to connect persons based on specific time, place, activity, and/or other associations created by various Timeline Authors, and specifically the current invention will allow for a Timeline Author to compare their Timeline Data with that of one or more other Timeline Authors, and having such comparisons result in the delivery to the Timeline Author of a list of other persons with specific shared experiences tied to time, place, activity, or other specified association. The greater the overlap of the shared experience, the higher the ranking. Similarly, the rankings can be more heavily weighted by the Timeline Author by one criteria over another (e.g., a Timeline Author can ask the system for lists of the most similar other timelines according to place criteria during a set period of time, limited also by a particular professional affiliation such as an architect or other professional qualifier).

Further, the current invention can allow for the Timeline Author to request suggested timelines for review from other parties (including the Social Networking Timeline System itself), or make its own Timeline Data available for search by other Timeline Authors.

By enabling these comparisons of timelines (through Timeline Author searching, third party recommendation, or third parties searching for the Timeline Author's Timeline Data) the subject invention solves the shortcomings of the prior art and creates a new mechanism by which people can search out and make meaningful new social connections via the Internet.

### SUMMARY

The subject invention relates generally to user-generated content sharing systems and associated methods of operation and relates to a social networking system that is accessible by a plurality of entities over a network such as the Internet and engages in the creation, storing, searching, and access of user-generated personal history timeline data.

Specifically, the Social Networking Timeline System allows individuals wishing to document and record their life histories over a timeline in an online venue (“Timeline Authors”) to create, upload, store, and share personal history information about themselves or others (“Timeline Data”) to a remote database designed to record, store, and parse the Timeline Data (called a “Social Networking Timeline System” or “Timeline System”), preferably over the Internet. These Timeline Authors are able to connect to other Timeline Authors thus establishing social connections. These links are to be characterized based upon the historical overlaps between all parties based upon their historical inputs, including but not limited to where they were at that point in time, what they were doing (job, schooling, marital status, parental status, sports, hobbies, clubs, vacation, travels, etc.), what their physical condition was (healthy, sick, recovering, etc.), who their associates were (girlfriend, boyfriend, colleagues, family members, etc.), what they affiliated with (cars owned, home location, musical tastes, books read, films seen, politicians they voted for, etc.), what their beliefs were (religions, political views, etc.), what events they were close to (elections, storms, disasters, sporting events, etc.). Thereafter, the information of each user may be searchable (anonymized or not) and connections may be requested between persons with shared historical characteristics at the corresponding point in history.

The method and apparatus may comprise a tangible machine readable medium storing instructions that, when executed by a computing device, cause the computing device to perform a method, which may comprise creating a data set accessible by a plurality of entities over a network such as the Internet and engage in the creation, storing, searching, and accessing of user-generated personal history timeline data.

The system and method may be implemented on a computing device utilizing instructions from a tangible machine readable medium.

### Incorporation by Reference

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The features, aspects and advantages of the disclosed and claimed subject matter of the present application are set forth with particularity in the appended claims. A better understanding of the aspects, features and advantages of the disclosed and claimed subject matter will be obtained by reference to the following detailed description that sets forth what are meant to be only illustrative embodiments and not limiting disclosures, in which the principles of the invention are utilized, and the accompanying drawings of which:

FIG. 1 illustrates a visual representation of a system and method for promoting social networking timeline activity according to aspects of embodiments of the disclosed subject matter as rendered on a display device such as a computer, cell phone, tablet, or television showing four distinct horizontal timeline types over a period of six decades;

FIG. 2 illustrates a visual representation of a system and method for promoting social networking timeline activity according to aspects of embodiments of the disclosed subject matter as rendered on a display device such as a computer, cell phone, tablet, or television showing two distinct horizontal timeline types over a period of six decades;

FIG. 3 illustrates a visual representation of a system and method for promoting social networking timeline activity according to aspects of embodiments of the disclosed subject matter as rendered on a display device such as a computer, cell phone, tablet, or television showing four distinct horizontal timeline types over a period of one decade;

FIG. 4 illustrates a visual representation of a system and method for promoting social networking timeline activity according to aspects of embodiments of the disclosed subject matter as rendered on a display device such as a computer, cell phone, tablet, or television showing a sample user input form for creating a timeline event entry relating to a particular job (a sample timeline category type) of the Timeline Author for inclusion in a professional timeline type;

FIG. 5 illustrates a conceptual relationship matrix of a system and method for promoting social networking timeline activity according to aspects of embodiments of the disclosed subject matter pertaining to the identification of and potential connecting of various individual Timeline Authors based upon their all having a shared historical event in their respective pasts; and

FIG. 6 illustrates a conceptual relationship matrix of a system and method for promoting social networking timeline activity according to aspects of embodiments of the disclosed subject matter pertaining to the identification of and potential connecting of various individual Timeline Authors based upon at least two of the Timeline Authors in a sequence having at least one shared historical event in their respective pasts and where a connectivity chain based upon degrees of separation can be assembled based upon these chains of shared events (“degrees of separation” chain based upon shared events).

### DETAILED DESCRIPTION

Aspects, features and advantages of the disclosed and claimed subject matter can be seen in the description herein of a user-generated personal history timeline content sharing system, also referred to as the Social Networking Timeline System (“Timeline System”). The Timeline System appeals to a wide range of people by (a) including easy to control biographical features, (b) offering a uniquely compelling vision of long-term life history, (c) including a means for searching for other similar timelines and events stored within the Timeline System, and (d) providing effective content access control. The subject invention described herein also includes a related website, methods, and software products. However, for convenience, the subject invention will be referred to primarily as the Timeline System, but this should not in any way be read as limiting. Furthermore, one embodiment of the subject invention is implemented under the trade name “VeryGoodYears” and can be accessed via the Internet at the URL http://www.verygoodyears.com. However, this implementation of the subject invention is only one possible implementation possible within the scope of the claims and therefore should not be considered limiting in anyway.

In operation, individuals wishing to document and record their life histories over a timeline in an online venue (the “Timeline Authors”) use the Timeline System to generate detailed timelines (personal history information about the Timeline Authors—“Timeline Data”) documenting their lives, and this data in turn can be the basis for the creation of blogs (i.e., web logs), journals, and personal profiles, as well as share photos, videos, audio files, and text documents. The Timeline System chronicles a person's historic life by organizing and maintaining the historic content entered over time. The Timeline System saves selected content and organizes it along the completed historic timeline according to various categories and sub-categories (travels, profession, possessions owned, schooling, etc.) and therefore depicting a Timeline Author's history, values, and accomplishments.

By using the Timeline System, Timeline Authors can: (a) write and share personal stories covering their life history, (b) search for similarly situated persons with shared characteristics over time, (c) allow other Timeline Authors to search for the original Timeline Authors, and (d) allow for Timeline Authors to connect to each other after having identified shared historical events and/or characteristics.

A user accesses the Timeline System via a personal computer or other computing device that is in communication with a network, such as the Internet. In one embodiment, the user utilizes a web browser, (e.g., Microsoft Internet Explorer or Mozilla Firefox) to access the Timeline System. The user interface of the Timeline System resembles an operating system “desktop” embedded in the web browser window. The user is able to access the various functionality of the Timeline System via the user interface. Those skilled in the art will realize alternative embodiments that provide access to the Timeline System by the user.

Of note, the current invention sets forth a novel method of determining a relative strength of shared historical experiences between two or more entities utilizing the Social Networking Timeline System, said method comprising the steps:
a. a particular user (“Timeline Author”) authoring a self history of personal characteristics they recall being associated with given periods of time in their lives and entering such paired time and characteristic data (“Timeline Data”) into an online data registry according to various categories and sub-categories within or accessible by the Social Networking Timeline System;
b. at the direction of the Timeline Author, comparing and/or overlaying the Timeline Data of a particular Timeline Author with the Timeline Data of another Timeline Author(s) whose distinct Timeline Data is stored in the same Social Networking Timeline System or accessible by the Social Networking Timeline System;
c. following a data registry search by a Timeline Author, highlighting those instances where the Timeline Data of one or more Timeline Authors is similar or identical; and
d. following a data registry search by a Timeline Author, ranking the strength of potential shared experiences amongst particular Timeline Authors by citing certain quantitative and qualitative instances where Timeline Authors had shared characteristics at given points in time.

Further, the Timeline Data may encompass subject matters (“Characteristic Tables”) including (but not be limited to):
a. where the Timeline Author was physically located at that point in time;
b. what the Timeline Author was doing at that point in time (job held, school attended, married, parenting, sports participation, hobby participation, club participation, vacations taken, travels engaged in, etc.);
c. what the Timeline Author's physical condition was (healthy, sick, recovering, etc.);
d. who the Timeline Author associated with (girlfriend(s), boyfriend(s), colleagues, family members, etc.);
e. what the Timeline Author affiliated with (cars driven, homes lived in, music listened to, books read, films seen, politicians they voted for, etc.);
f. what the Timeline Author's beliefs were (religions, political views, etc.);
g. what events the Timeline Author was associated with (elections, storms, disasters, sporting events, etc.); and
h. who the Timeline Author is based upon demographic profiles (age, race, religion, sex, sexual orientation, physical handicap, marital status, nationality, parental status, etc.).

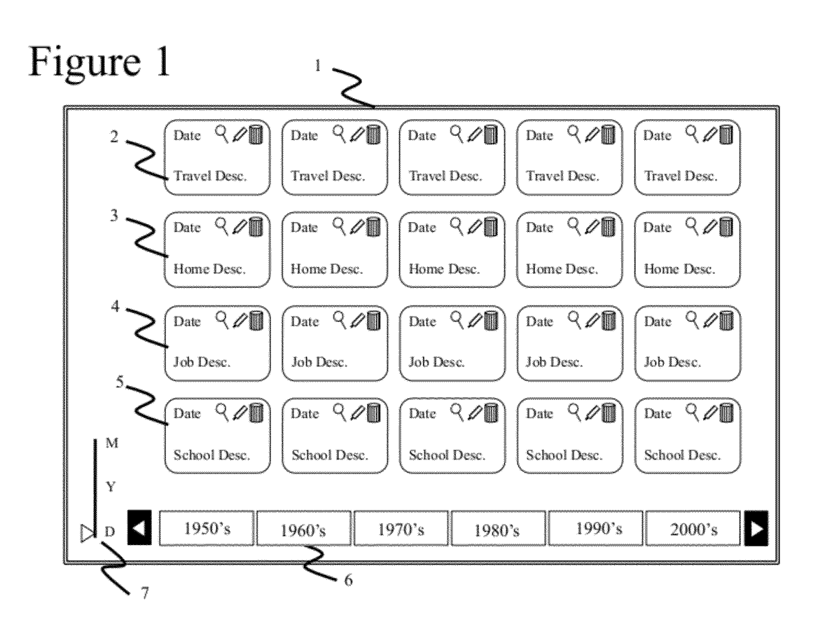

In terms of implementation, the Timeline Data subject matters can take the form of various distinct timelines (left to right, up and down, color coded, and/or utilizing analogous visual cues to make the distinctions between timeline types). By way of example, FIG. 1 shows a basic set of timeline subject matter categories as may appear on a computer screen 1 (e.g., through a web browser or app) of a viewer, each one distinct from the others, arranged horizontally and spaced according to various decades 6 in which they occurred and or overlapped. In this example, there are four timeline categories pertaining to where the Timeline Author has travelled (top line 2), where they resided (homes) 3, where they worked (jobs/professional) 4, and where they went to school (education and/or course work) 5. To the left is a time period toggle bar 7 that would allow the viewer to change the viewing parameters of the screen, allowing the view to widen or narrow according to month (“M”), year (“Y”), or decade (“D”). However, other toggle parameters are possible.

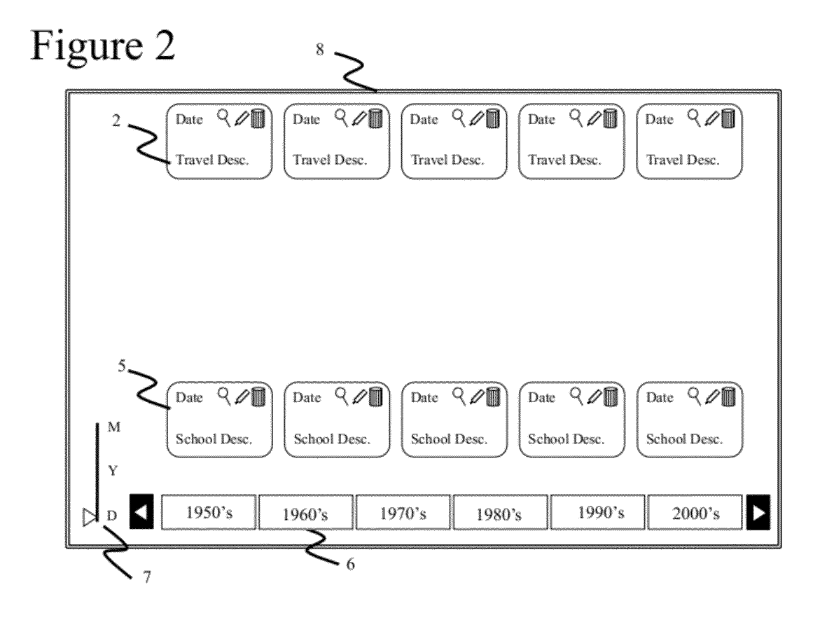

In contrast, in FIG. 2 the Timeline Data subject matters have been altered by the viewer to show on the screen 8 only two categories of timeline—the travel timeline 2 and the school/education timeline 5. However, the period tracked remains the same (multi decade views 6) as dictated by the toggle bar 7 being set at the multiple “decade” view setting (“D”).

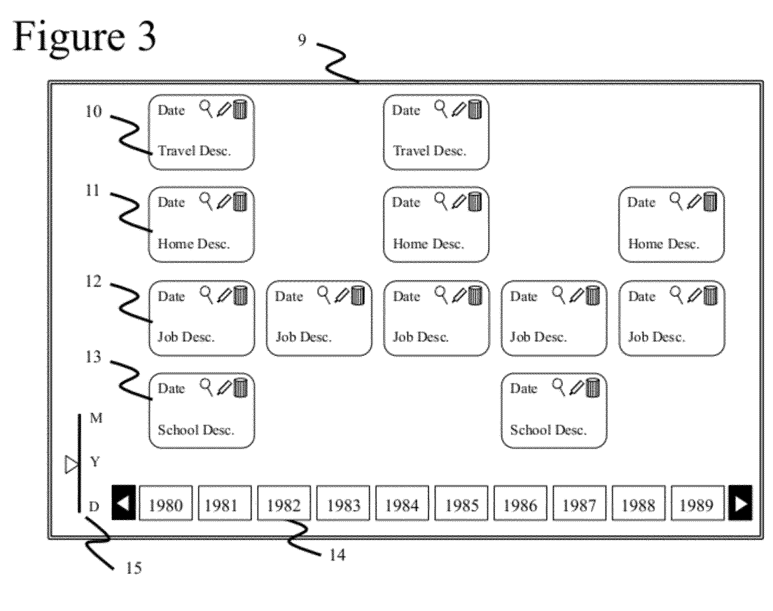

In further contrast, in FIG. 3 the Timeline Data subject matters have not been altered by the viewer on the screen 9 (still showing four categories relating to travel 10, residence 11, job 12, and schooling 13). However, the period tracked 14 is altered to show years from only one particular decade (the 1980′s) and this is accomplished through the toggle bar 15 that is now set to “years” (“Y”).

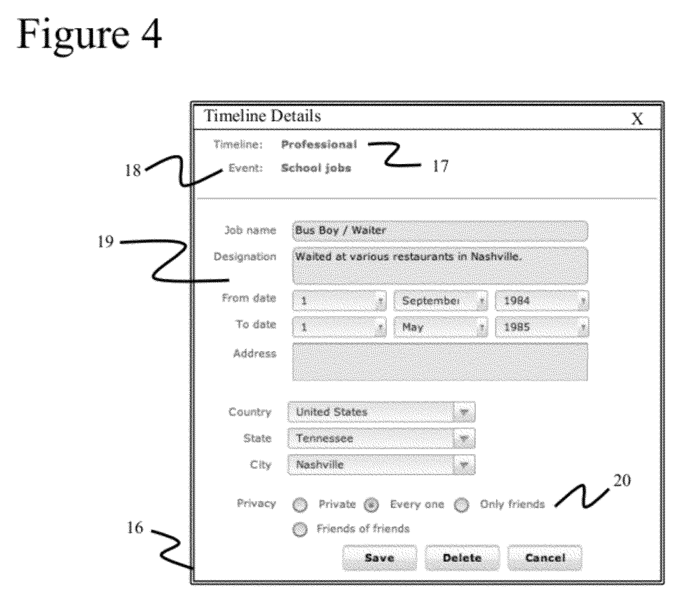

In FIG. 4 one can see an example of how each timeline entry is created by the system and the Timeline Author. In this case, the Timeline Author is prompted by the system to input data in a form field box 16 that pertains to an entry into a particular timeline category relating to a Timeline Author's job and/or profession 17. Therein the system seeks information relating to the type of job and/or professional event being authored 18 and other specific descriptive data and date ranges 19 relating to the timeline entry being created. Lastly, the entry box seeks information from the Timeline Author on whom the timeline entry data should be accessible by 20 (family, friends, public, etc.).

In addition, the Timeline Data may be searched, sorted, ranked, or otherwise reformatted according to one or more Characteristic Tables over any designated period of time with the results presented to the Timeline Author conducting the search.

Furthermore, the subject invention includes a method of determining a relative strength of a connection between two or more entities utilizing the Timeline System based upon their shared historic experiences as documented over a timeline. The method includes the step of calculating a quantitative index regarding the connection utilizing at least one quantitative factor as designated either by the system or the party performing the search. The method also includes the step of calculating a qualitative index regarding the connection utilizing at least one qualitative factor designated either by the system or the party performing the search. The relative strength of the connection is then calculated utilizing the quantitative index and the qualitative index. The quantitative factors relating to ranking of a data registry search include (but are not limited to) the number of matching Timeline Author characteristics relative to any given period of time, the length of such matching characteristics, and the start and end period for such matching characteristics. The qualitative factors relating to ranking of a data registry search include (but are not limited to) the subjective importance (weighting) provided by the Timeline Author of matching Timeline Author characteristics relative to any given period of time.

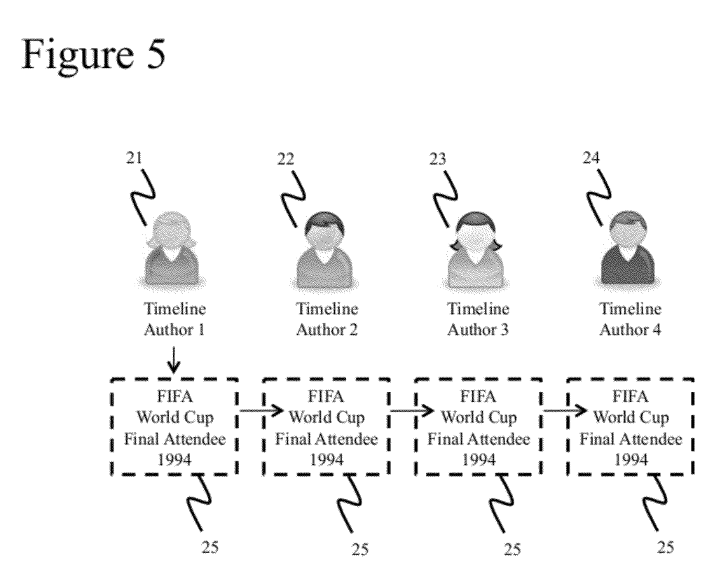

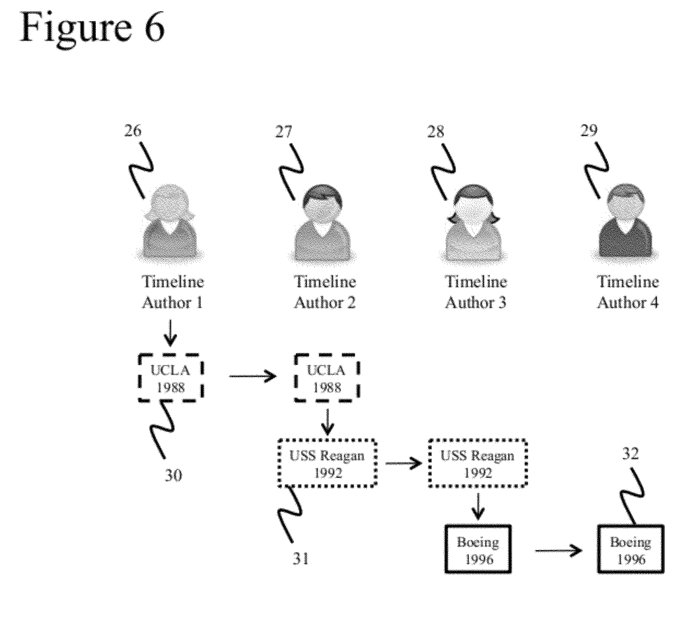

By way of example, a strong connection element between various parties could be formed by their having a unique particular shared event (same time, place, activity) and represented graphically in FIG. 5 where the various Timeline Authors (21, 22, 23, and 24) each have experienced an identifiable and distinct shared event 25 (FIFA World Cup Final Attendee 1994). Whereas, in FIG. 6 a less strong connection could be determined through a “chain” of shared events (“degrees of separation” chain based upon shared events) based upon at least two of the Timeline Authors (26, 27, 28. 29) in a sequence having at least one shared historical event (any one or more of 30, 31, and 32) in their respective pasts and where a chain based upon degrees of separation can be assembled based upon these chains of shared events. Nonetheless, such a chain could prove very popular with users as it would allow them to see how closely connected they were to particular persons and events not based upon their having a personal social relationship with other value chain members (friends, family, acquaintances) but instead a shared chain of experiences. Moreover, the number and types of chains that could be constructed in this manner are potentially much higher than prior art social chains based upon connections fostered by chain participants actually socially “knowing” each other previously.

The subject invention also includes a method of limiting the sharing of information in the Timeline System. The method includes the step of receiving information from a first user and a second or other further users(s). The information from the first user is stored in a computerized database as a first user record and information from the second or further user(s) is stored in the computerized database as a second user record. The method also includes the step of receiving connection data relating to a connection between the users. The connection data is stored in the computerized database. The method further includes receiving first user category data for categorizing the connection between the first user and the second user from the perspective of the first user. The first user category data is also stored in the computerized database. Specifically, the Timeline Data of a Timeline Author may be made searchable by other Timeline Authors on either an anonymous basis or a pre-screened basis (previously authorized friends, family members, person types, etc.). Moreover, the Timeline Author of Timeline Data that matches the Timeline Data of another Timeline Author may be contacted directly or anonymously for the purposes of introducing (socially connecting) the parties matched by the Social Networking Timeline System. Furthermore, the search of Timeline Data may produce relationship maps (e.g, geographical, social connection links by degrees of separation, shared event history links by degrees of separation) showing those other Timeline Authors who share Timeline Data as segmented by Characteristic Table data, and may further be empowered with features that initiate new actions on behalf of a Timeline Author or Timeline System (e.g., at the happening of a particular search result, comparison, social connection, passage of time, or analogous event the Timeline Author and/or Timeline System may undertake a particular action such as making new “quarantined or embargoed” Timeline Data available to additional Timeline System users or to direct a third party to take a particular action such as the delivery of a gift to the viewer of the recently un-embargoed Timeline Data).

Further, the subject invention also allows for third party annotations to be included on a particular Timeline Author's timeline if authorized in advance by the Timeline Author of such Timeline Data. For instance, the annotation could seek to correct an input by a Timeline Author, or expand upon a particular description previously recorded by the Timeline Author. Or, in another embodiment the annotation could take the form of a data entry indicating that someone other than the Timeline Author was present at the subject time and place (e.g., “I was there too” function). Similarly, where the event being described was not specific to a particular place, an annotation function could indicate where one or more persons other than the Timeline Author were when the event described by the Timeline Author transpired (e.g., “where were you when?” function).

In the foregoing specification, the disclosure has been described with reference to specific exemplary embodiments thereof It will be evident that various modifications may be made thereto without departing from the broader spirit and scope as set forth in the following claims. The specification and drawings are, accordingly, to be regarded in an illustrative sense rather than a restrictive sense.

What is claimed is:

1. A method of determining a relative strength of shared historical experiences between two or more entities utilizing the Social Networking Timeline System, said method comprising the steps:
a. a particular user (“Timeline Author”) authoring a self history of personal characteristics they recall being associated with given periods of time in their lives and entering such paired time and characteristic data (“Timeline Data”) into an online data registry according to various categories and subcategories within or accessible by the Social Networking Timeline System;
b. at the direction of the Timeline Author, comparing and/or overlaying the Timeline Data of a particular Timeline Author with the Timeline Data of another Timeline Author(s) whose distinct Timeline Data is stored in the same Social Networking Timeline System or accessible by the Social Networking Timeline System;
c. following a data registry search by a Timeline Author, highlighting those instances where the Timeline Data of one or more Timeline Authors is similar or identical; and
d. following a data registry search by a Timeline Author, ranking the strength of potential shared experiences amongst particular Timeline Authors by citing certain quantitative and qualitative instances where Timeline Authors had shared characteristics at given points in time.

2. A method as set forth in claim 1 wherein the Timeline Data may encompass subject matters (“Characteristic Tables”) including (but not be limited to):
a. where the Timeline Author was physically located at that point in time;
b. what the Timeline Author was doing at that point in time (job held, school attended, married, parenting, sports participation, hobby participation, club participation, vacations taken, travels engaged in, etc.);
c. what the Timeline Author's physical condition was (healthy, sick, recovering, etc.);
d. who the Timeline Author associated with (girlfriend(s), boyfriend(s), family members, etc.);
e. what the Timeline Author affiliated with (cars driven, homes lived in, music listened to, books read, films seen, politicians they voted for, etc.);
f. what the Timeline Author's beliefs were (religions, political views, etc.);
g. what events the Timeline Author was associated with (elections, storms, disasters, sporting events, etc.); and
h. who the Timeline Author is based upon demographic profiles (age, race, religion, sex, sexual orientation, physical handicap, marital status, nationality, parental status, etc.).

3. A method as set forth in claim 2 wherein the Timeline Data may be searched, sorted, ranked, or otherwise reformatted according to one or more Characteristic Tables over any designated period of time with the results presented to the Timeline Author conducting the search.

4. A method as set forth in claim 3 wherein the quantitative factors relating to ranking of a data registry search include the number of matching Timeline Author characteristics relative to any given period of time, the length of such matching characteristics, and the start and end period for such matching characteristics.

5. A method as set forth in claim 3 wherein the qualitative factors relating to ranking of a data registry search include the subjective importance (weighting) provided by the Timeline Author of matching Timeline Author characteristics relative to any given period of time.

6. A method as set forth in claim 4 wherein qualitative factors relating to ranking of a data registry search including the subjective importance (weighting) provided by the Timeline Author of matching Timeline Author characteristics relative to any given period of time is combined with with those of quantitative factors.

7. A method as set forth in claim 5 wherein quantitative factors relating to ranking of a data registry search including the number of matching Timeline Author characteristics relative to any given period of time, the length of such matching characteristics, and the start and end period for such matching characteristics is combined with with those of qualitative factors.

8. A method as set forth in claim 3 wherein the Timeline Data of a Timeline Author may be searched for relative strength matching by other Timeline Authors on either an anonymous basis or a pre-screened basis (previously authorized friends, family members, pre-determined author characteristics, etc.).

9. A method as set forth in claim 3 wherein the Timeline Author of Timeline Data that perfroms a search and matches a relative strength threshold of another Timeline Author may be contacted directly or anonymously for the purposes of introducing (socially connecting) the parties matched by the Social Networking Timeline System.

10. A method as set forth in claim 3 wherein a search for relative strength matching of Timeline Data produces one or more relationship maps showing those other Timeline Authors who share Timeline Data as segmented by Characteristic Table data.

11. A method as set forth in claim 3 wherein a search for relative strength matching of Timeline Data produces a list of relevant content (newspaper clippings, ads, radio shows, TV shows, books, movies) that was available at that particular time and in that particular place, and for providing a mechanism for the creator of such search to view such content, whether on a fee basis or otherwise.

12. A method as set forth in claim 3 wherein the creation of Timeline Data by a Timeline Author for use in a relative strength matching search of Timeline Data is facilitated by the use of a template that already has certain Timeline Data preloaded and therefore supplements the creation of the Timeline Author's own searchable relative strength matching Timeline Data.

13. A method as set forth in claim 3 wherein a search for relative strength matching of Timeline Data is facilitated by the importation of additional multimedia resources, including but not limited to photos, video, music, audio clips, written passages, news clips, web sites, maps, text messages, and hyperlinks to other data sources, with or without password authorized access requirements.

14. A method as set forth in claim 3 wherein a search for relative strength matching of Timeline Data pertaining to one Timeline Author is comparable to other timelines relating to persons, things, or events that are not authored by Timeline Authors documenting their own lives, but instead documenting such other person, things, or events in timeline form from a third party perspective.

15. A method as set forth in claim 3 wherein a search for relative strength matching of Timeline Data can be visually presented as various categories and sub-categories of Timeline Data represented in separate timelines within the Timeline System, and viewed independently or in various combinations as new timeline subsets.

16. A method wherein the creation of Timeline Data by a Timeline Author produces results that graded, awarded “points”, and/or ranked by the Timeline System based upon the completeness of the input, whether such assessment is relative to the amount of data completeness exhibited by other similar datasets provided by other Timeline Authors or whether compared to a pre-determined completeness profile acting as a benchmark.

17. A method wherein the creation of various categories and sub-categories of Timeline Data can be viewed by certain pre-determined persons identified by the Timeline Author (whether individuals or groups) based upon their particular characteristics and relationship to the Timeline Author as defined by the Timeline Author at the time the dataset is created.

18. A method wherein the various categories and sub-categories of Timeline Data can be viewed by certain pre-determined persons identified by the Timeline Author (whether individuals or groups) only upon the happening of a pre-conditioned event as defined by the Timeline Author at the time the dataset is created.

19. A method wherein the various categories and sub-categories of Timeline Data can be embedded with certain contextually related pre-determined courses of action, including the delivery of a particular predetermined message by the Timeline Author and/or the delivery of goods and services already paid for by the Timeline Author, to be effected by the Timeline System for the benefit of persons identified by the Timeline Author (whether individuals or groups) only upon the happening of a pre-conditioned event as defined by the Timeline Author at the time the Timeline Data is created.

20. A method wherein the Timeline Data produces a relationship “degree of separation” map between two or more persons who do not have shared Timeline Data dataset elements relative to each other, but share one or more Timeline Data dataset elements with at least one or more other intermediary persons whose Timeline Data is incorporated into the Timeline System.

21. A method as set forth in claim 3 wherein a search for relative strength matching of Timeline Data produces a relationship “degree of separation” map between two or more persons who do not have shared Timeline Data dataset elements relative to each other, but share one or more Timeline Data dataset elements with at least one or more other intermediary persons whose Timeline Data is incorporated into the Timeline System.

22. A method as set forth in claim 20 wherein the Timeline Data relationship “degree of separation” map between two or more persons who do not have shared Timeline Data dataset elements relative to each other may be presented according to intermediate dataset elements linked to one or more characteristic subject matters.

23. A method as set forth in claim 20 wherein the Timeline Data relationship “degree of separation” map between two or more persons who do not have shared Timeline Data dataset elements relative to each other may be presented in terms of link proximity according to the number of intermediate dataset elements between the two or more persons who do not have shared Timeline Data dataset elements relative to each other.

24. A tangible machine readable medium storing instructions that, when executed by a computing device, cause the computing device to perform a method of determining a relative strength of shared historical experiences between two or more entities utilizing the Social Networking Timeline System, said method comprising the steps:
a. a particular user (“Timeline Author”) authoring a self history of personal characteristics they recall being associated with given periods of time in their lives and entering such paired time and characteristic data (“Timeline Data”) into an online data registry according to various categories and subcategories within or accessible by the Social Networking Timeline System;
b. at the direction of the Timeline Author, comparing and/or overlaying the Timeline Data of a particular Timeline Author with the Timeline Data of another Timeline Author(s) whose distinct Timeline Data is stored in the same Social Networking Timeline System or accessible by the Social Networking Timeline System;
c. following a data registry search by a Timeline Author, highlighting those instances where the Timeline Data of one or more Timeline Authors is similar or identical; and
d. following a data registry search by a Timeline Author, ranking the strength of potential shared experiences amongst particular Timeline Authors by citing certain quantitative and qualitative instances where Timeline Authors had shared characteristics at given points in time.

25. A tangible machine readable medium storing instructions that, when executed by a computing device, cause the computing device to perform a method as set forth in claim 25 wherein the Timeline Data may encompass subject matters (“Characteristic Tables”) including (but not be limited to):
a. where the Timeline Author was physically located at that point in time;
b. what the Timeline Author was doing at that point in time (job held, school attended, married, parenting, sports participation, hobby participation, club participation, vacations taken, travels engaged in, etc.);
c. what the Timeline Author's physical condition was (healthy, sick, recovering, etc.);
d. who the Timeline Author associated with (girlfriend(s), boyfriend(s), family members, etc.);
e. what the Timeline Author affiliated with (cars driven, homes lived in, music listened to, books read, films seen, politicians they voted for, etc.);
f. what the Timeline Author's beliefs were (religions, political views, etc.);
g. what events the Timeline Author was associated with (elections, storms, disasters, sporting events, etc.); and
h. who the Timeline Author is based upon demographic profiles (age, race, religion, sex, sexual orientation, physical handicap, marital status, nationality, parental status, etc.).

26. A networked apparatus comprising:
a. a memory;
b. a processor;
c. a communicator;
d. a display; and
e. a suite of software capable of determining a relative strength of shared historical experiences between two or more entities utilizing the Social Networking Timeline System, said method comprising the steps of: (i) particular user (“Timeline Author”) authoring a self history of personal characteristics they recall being associated with given periods of time in their lives and entering such paired time and characteristic data (“Timeline Data”) into an online data registry according to various categories and subcategories within or accessible by the Social Networking Timeline System; (ii) at the direction of the Timeline Author, comparing and/or overlaying the Timeline Data of a particular Timeline Author with the Timeline Data of another Timeline Author(s) whose distinct Timeline Data is stored in the same Social Networking Timeline System or accessible by the Social Networking Timeline System; (iii) following a data registry search by a Timeline Author, highlighting those instances where the Timeline Data of one or more Timeline Authors is similar or identical; and (iv) following a data registry search by a Timeline Author, ranking the strength of potential shared experiences amongst particular Timeline Authors by citing certain quantitative and qualitative instances where Timeline Authors had shared characteristics at given points in time.

27. A networked apparatus comprising:
a. a memory;
b. a processor;
c. a communicator;
d. a display; and
e. a suite of software as set forth in claim 27 wherein the Timeline Data may encompass subject matters (“Characteristic Tables”) including (but not be limited to): (i) where the Timeline Author was physically located at that point in time; (ii) what the Timeline Author was doing at that point in time (job held, school attended, married, parenting, sports participation, hobby participation, club participation, vacations taken, travels engaged in, etc.); (iii) what the Timeline Author's physical condition was (healthy, sick, recovering, etc.); (iv) who the Timeline Author associated with (girlfriend(s), boyfriend(s), family members, etc.); (v) what the Timeline Author affiliated with (cars driven, homes lived in, music listened to, books read, films seen, politicians they voted for, etc.); (vi) what the Timeline Author's beliefs were (religions, political views, etc.); (vii) what events the Timeline Author was associated with (elections, storms, disasters, sporting events, etc.); and (viii) who the Timeline Author is based upon demographic profiles (age, race, religion, sex, sexual orientation, physical handicap, marital status, nationality, parental status, etc.).
